(19) United States
(12) Patent Application Publication
(10) Pub. No.: US 2012/0166190 A1
(43) Pub. Date: Jun. 28, 2012

(54) APPARATUS FOR REMOVING NOISE FOR SOUND/VOICE RECOGNITION AND METHOD THEREOF

(75) Inventors: Jae Yeon Lee, Daejeon (KR); Mun Sung Han, Daejeon (KR); Jae Il Cho, Daejeon (KR); Jae Hong Kim, Daejeon (KR); Joo Chan Sohn, Daejeon (KR)

(73) Assignee: Electronics and Telecommunications Research Institute, Daejeon (KR)

(21) Appl. No.: 13/326,768

(22) Filed: Dec. 15, 2011

(30) Foreign Application Priority Data
Dec. 23, 2010 (KR) 10-2010-0134080

(51) Int. Cl. G10L 15/20

(52) U.S. Cl. 704/233; 704/E15.039

(57) ABSTRACT

The present invention has been made in an effort to provide an apparatus for removing noise for sound/voice recognition removing a TV sound corresponding to a noise signal by using an adaptive filter capable of adapting a filter coefficient in order to remove an analogue signal and performing sound and/or voice recognition and a method thereof.

### CROSS-REFERENCE TO RELATED APPLICATIONS

This application claims priority to and the benefit of Korean Patent Application No. 10-2010-0134080 filed in the Korean Intellectual Property Office on Dec. 23, 2010, the entire contents of which are incorporated herein by reference.

### TECHNICAL FIELD

The present invention relates to an apparatus for removing noise for sound/voice recognition removing a TV sound corresponding to noise in a cogno TV or removing interference based on a pre-known sound and performing sound and/or voice recognition and a method thereof.

### BACKGROUND ART

A television (hereinafter, referred to as a ‘TV’) as an image signal controlling device is a device that performs predetermined signal processing for a received broadcasting signal (including decoding, amplifying, and the like) and outputs image data and/or voice data included in the predetermined signal processed broadcasting signal.

In particular, a cogno TV recognizing a motion and controlling the operation of the TV based on the recognized motion is irrelative to the TV sound in the case of a motion (or a gesture), but in the case of the sound and/or voice recognition, a correlation between the cogno TV and the TV sound becomes higher, such that recognition rate for the sound and/or voice is largely reduced.

In the case of a general cogno TV, the sound and/or voice recognition is performed by using a subtraction method in a time domain by using information on the TV sound used as a reference, a spectral subtraction method, and the like, but since the TV sound used as the reference and the TV sound in a mike input terminal used for the sound and/or voice recognition are similar to each other, but are not equal to each other, the TV sound corresponding to the noise is not completely removed and also, sound and/or voice signals are partially removed.

### SUMMARY OF THE INVENTION

The present invention has been made in an effort to provide an apparatus for removing noise for sound/voice recognition removing a TV sound corresponding to a noise signal by using an adaptive filter capable of adapting a filter coefficient in order to remove an analogue signal and performing sound and/or voice recognition and a method thereof.

An exemplary embodiment of the present invention provides an apparatus for removing noise for sound/voice recognition which removes a noise signal included in a signal received through a mike, the apparatus including: a first low-pass filter filtering the signal received through the mike based on a predetermined first cutoff frequency; a second low-pass filter filtering digitized audio data before being outputted through a speaker provided in a TV based on a predetermined second cutoff frequency; an adaptive filter controlling a coefficient of the filter based on an output signal of an adding and subtracting unit and filtering an output signal of the second low-pass filter based on the controlled coefficient; an adding and subtracting unit adding or subtracting an output signal of the first low-pass filter and an output signal of the adaptive filter; and a controlling unit voice-recognizing a signal outputted from the adding and subtracting unit and controlling a function or an operation of the TV based on the voice recognition result.

The mike may receive the signal through the mike when a predetermined motion of an object is detected in the image information received through the camera.

The first cutoff frequency or the second cutoff frequency may be 8 kHz.

The signal received through the mike may include a sound signal, a voice signal, and an audio signal outputted through the speaker.

The controlling unit may output a screen displayed on a display unit of the TV based on the voice recognition result or transmit the screen to any communication-connected terminal.

The predetermined motion of the object may include any one of a gesture drawing a circle in a clockwise direction or a counterclockwise direction, a sliding gesture in any direction, and a gesture drawing a polygon.

The controlling unit may control a function of the TV including a content of any one of a channel, volume, mute, and an environment which corresponds to the voice recognition result from a time when the motion of the object is detected when a sound level outputted through the speaker is equal to or larger than a predetermined level.

The controlling unit may perform an auto-correlation between the digitized audio data before being outputted through the speaker provided in the TV and the signal received through the mike.

Another exemplary embodiment of the present invention provides a method for removing noise for sound/voice recognition which removes a noise signal included in a signal received through a mike, the method including: detecting a motion of an object included in image information received through a camera; receiving a signal through the mike when the detected motion of the object is a predetermined motion; filtering the signal received through the mike through a first low-pass filter based on a predetermined first cutoff frequency; filtering digitized audio data before being outputted through a speaker provided in a TV through a second low-pass filter based on a predetermined second cutoff frequency; controlling a coefficient of an adaptive filter based on an output signal of an adding and subtracting unit and filtering an output signal of the second low-pass filter through the adaptive filter based on the controlled coefficient; adding or subtracting an output signal of the first low-pass filter and an output signal of the adaptive filter; voice-recognizing an output signal according to the addition or subtraction; and controlling a function or an operation of the TV based on the voice recognition result.

The controlling of the function or operation of the TV based on the voice recognition result may output a screen displayed on a display unit of the TV through a printer based on the voice recognition result or transmit the screen to any communication-connected terminal.

The method may further include controlling a function of the TV including a content of any one of a channel, volume, mute, and an environment which corresponds to the voice recognition result from a time when the motion of the object is detected when a sound level outputted through the speaker is equal to or larger than a predetermined level.

The method may further include performing an auto-correlation between the digitized audio data before being outputted through the speaker provided in the TV and the signal received through the mike.

The present invention provides the following effects.

First, according to exemplary embodiments of the present invention, it is possible to increase a recognition rate for the sound and/or voice by removing the TV sound corresponding to the noise signal by using the adaptive filter in the sound and/or voice recognition of the cogno TV.

Second, according to exemplary embodiments of the present invention, it is possible to increase a recognition rate for the sound and/or voice by controlling a coefficient of the adaptive filter by using a digitized signal before being outputted of a TV speaker as a reference signal and removing the TV sound.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a configuration diagram of an apparatus for removing noise for sound/voice recognition according to an exemplary embodiment of the present invention.

FIG. 2 is a flowchart illustrating a method for removing noise for sound/voice recognition according to an exemplary embodiment of the present invention.

FIG. 3 is a flowchart illustrating a method for removing noise for sound/voice recognition according to an exemplary embodiment of the present invention.

FIG. 4 is a flowchart illustrating a method for removing noise for sound/voice recognition according to an exemplary embodiment of the present invention.

FIG. 5 is a flowchart illustrating a method for removing noise for sound/voice recognition according to an exemplary embodiment of the present invention.

FIG. 6 is a flowchart illustrating a method for removing noise for sound/voice recognition according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention. It should be understood that although exemplary embodiment of the present invention are described hereafter, the spirit of the present invention is not limited thereto and may be changed and modified in various ways by those skilled in the art.

Exemplary embodiments of the present invention may be implemented by various means. For example, the exemplary embodiments of the present invention may be implemented firmware, software, or a combination thereof, or the like.

In the implementation by the hardware, a method according to exemplary embodiments of the present invention may be implemented by application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, or the like.

In the implementation using the firmware or the software, a method according to exemplary embodiments of the present invention may be implemented by modules, procedures, functions, or the like, that perform functions or operations described above. Software codes are stored in a memory unit and may be driven by a processor. The memory unit is disposed in or out the processor and may transmit and receive data to and from the well-known various units.

Throughout the specification, when a predetermined portion is described to be “connected to” another portion, it includes a case where the predetermined portion is electrically connected to the other portion by disposing still another predetermined portion therebetween, as well as a case where the predetermined portion is directly connected to the other portion. Also, when the predetermined portion is described to include a predetermined constituent element, it indicates that unless otherwise defined, the predetermined portion may further include another constituent element, not precluding the other constituent element.

Also, the term module described in the present specification indicates a single unit to process a predetermined function or operation and may be configured by hardware or software, or a combination of hardware and software.

Specific terms are provided to help understandings of the present invention. The use of the specific terms may be changed into other forms without departing from the technical idea of the present invention.

The present invention relates to an apparatus for removing noise for sound/voice recognition removing a TV sound corresponding to a noise signal by using an adaptive filter capable of adapting a filter coefficient in order to remove an analogous signal and performing sound and/or voice recognition and a method thereof.

Hereinafter, exemplary embodiments of the present invention will be described in detail with reference to the accompanying drawings.

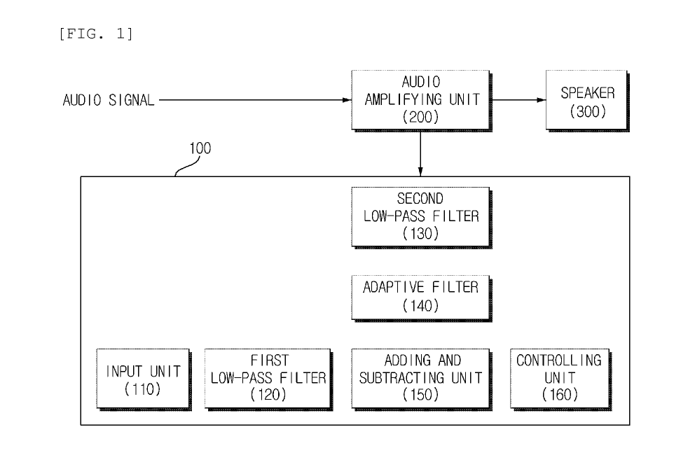

FIG. 1 is a configuration diagram of an apparatus for removing noise for sound/voice recognition according to an exemplary embodiment of the present invention.

The apparatus 100 for removing noise for sound/voice recognition according to an exemplary embodiment of the present invention includes an input unit 110, a first low-pass filter 120, a second low-pass filter 130, an adaptive filter 140, an adding and subtracting unit 150, and a controlling unit 160.

The input unit 110 according to the exemplary embodiment of the present invention may include at least one mike (not shown) for receiving an audio signal and/or at least one camera (not shown) for receiving a video signal. Further, the input unit 110 receives any sound signal (or sound information) and/or a user's voice signal (or user's voice information) through the mike. In this case, in the case where any sound signal and/or the user's voice signal are received through the mike, the audio signal of the TV outputted through a speaker 300 may be received together in addition to any sound signal and/or the user's voice signal.

In addition, the input unit 110 receives the signal corresponding to the information inputted by the user and various devices such as a key pad, a dome switch, a jogshuttle, a mouse, a stylus pen, a touch screen, a touch pad (static pressure/electrostatic), a touch pen, and the like may be used as the input unit 110.

The mike receives external sound signals (including a user's voice (voice signal or voice information), an audio signal of the TV outputted through the speaker 300, and the like) by a microphone in a calling mode, a recording mode, a voice recognition mode, a video conference mode, a video calling mode, and the like to process the external sound signals to electric voice data. The processed voice data (for example, including electric voice data corresponding to a sound signal, a voice signal, an audio signal of TV, and the like) may be outputted through the speaker 300 or converted and outputted in a transmittable form to an external terminal through a communication unit (not shown).

The camera processes an image frame of a still image (a gif form, a jpeg form, and the like) or a moving image (including a wma form, an avi form, an asf form, and the like) acquired by an image sensor (a camera module or a camera) in a video calling mode, a photographic mode, a video conference mode, and the like. That is, the corresponding image data acquired by the image sensor according to a codec are encoded so as to be suitable for each standard. The processed image frame may be displayed on a display unit (not shown) by the control of the controlling unit 160. As an example, the camera photographs an object or a subject (user image) and outputs the video signal corresponding to the photographed image (subject image). Further, the image frame processed in the camera may be stored in a storing unit (not shown) or transmitted to any external terminal communication-connected through a communicating unit (not shown).

That is, the input unit 110 receives multimedia information through the mike and/or the camera. Herein, the multimedia information (or data stream) includes sound information and voice information received through the mike, audio information outputted through the speaker 300, and video information/image information (including a still image, a moving image, and the like) received (or photographed) through the camera, and the like.

The first low-pass filter 120 according to the exemplary embodiment of the present invention low-pass filters data received through the mike included in the input unit 110 (including at least one of a sound signal, a voice signal, and an audio signal of a TV) based on a predetermined cutoff frequency (for example, 8 kHz). Further, the first low-pass filter 120 may apply various noise removing algorithms for removing the noise which is included in the data received through the mike included in the input unit 110.

The second low-pass filter 130 according to the exemplary embodiment of the present invention decodes the audio data included in any broadcasting signal by the control of a decoder (not shown) included in the TV or the controlling unit 160 and low-pass filters the decoded audio data based on a predetermined cutoff frequency (for example, 8 kHz). Herein, the decoded audio data is used as a reference signal in the apparatus 100 for removing noise for sound/voice recognition and is a digitized signal. Further, the decoded audio data is amplified through an audio amplifying unit 200 and the amplified audio data is outputted through the speaker 300.

The adaptive filter 140 according to the exemplary embodiment of the present invention controls (or updates) a coefficient of the adaptive filter 140 based on an output signal of the adding and subtracting unit 150 and filters an output signal of the second low-pass filter 130 based on the controlled coefficient to output the filtered output signal. That is, when a signal or a system parameter inputted to the adaptive filter 140 is changed, the adaptive filter 140 controls the coefficient of the filter through self-learning and filters the output signal of the second low-pass filter 130 by using the controlled coefficient.

The adaptive filter 140 controls the coefficient of the filter by using a least mean square (LMS) algorithm. That is, the adaptive filter 140 optimizes the coefficient of the filter by using the following Equations.

A signal outputted from the adding and subtracting unit 150 (or an error signal) is represented as follows.

e(n)=d(n)−y(n) [Equation 1]

Herein, e(n) represents an error signal outputted from the adding and subtracting unit 150, d(n) represents an output signal of the first low-pass filter, and y(n) represents an output signal of the adaptive filter 140.

y(n) is represented by the following Equation.

$$y ( n ) = {\sum }_{k = 0}^{N} w ( n , k ) x ( n - k ) \qquad [ Equation 2 ]$$

Herein, w(n, k) represents a coefficient of the filter and x(n−k) represents a digitized audio signal filtered by the second low-pass filter 130 (or decoded audio data used as a reference signal).

When the least mean square (LMS) algorithm is applied to Equation 1, the following Equation is represented.

E[e²(n)]=E[d²(n)]−2E[d(n)y(n)]+E[y²(n)] [Equation 3]

Herein, E[ ] represents an average.

For example, when a weight is 1, if Equation 2 is substituted into Equation 3, the following Equation 4 is represented.

E[e²(n)]=E[d²(n)]−2E[d(n)x(n)]w(0)+E[x²(n)]w²(0) [Equation 4]

Herein, if A=E[d(n)], β=E[d(n)x(n)], and C=E[x²(n)] are defined, Equation 4 is represented as follows.

E[e²(n)]=A−2βw(0)+Cw²(0) [Equation 5]

If Equation 5 is differentiated with respect to w(0), the following value is acquired.

w(0)=β/C [Equation 6]

That is, in Equation 6, Equation 5 has a minimum value and is the case where interference between the output signal of the first low-pass filter represented by d(n) and the output signal of the adaptive filter 140 represented by y(n) is minimized.

A next weight is represented by the following Equation. A previous weight is replaced with the next weight.

$$w ( 0 , n + 1 ) = w ( 0 , n ) - β \frac{d E [ {e}^{2} ( n ) ]}{d w ( 0 )} \qquad [ Equation 7 ]$$

The adding and subtracting unit 150 according to the exemplary embodiment of the present invention removes the audio signal of the TV included in the data received through the input unit 110 by adding (or subtracting) data outputted from the first low-pass filter 120 (for example, including electric voice data corresponding to a sound signal, a voice signal, an audio signal of a TV, and the like) and data outputted from the adaptive filter 140 (for example, including an audio signal of a TV corresponding to the reference signal and the like). Further, the adding and subtracting unit 150 transfers the output of the adding and subtracting unit 150 to the adaptive filter 140 or the controlling unit 160.

The controlling unit 160 according to the exemplary embodiment of the present invention performs a voice recognition process based on the data (or the signal) from which the audio signal of the TV outputted from the adding and subtracting unit 150 is removed and controls the TV provided with the apparatus 100 for removing noise for the sound/voice recognition so as to perform any function (or operation) based on the result of performing the voice recognition.

The controlling unit 160 extracts a feature vector from the data from which the audio signal of the TV outputted from the adding and subtracting unit 150 is removed and recognizes a speaker based on the extracted feature vector. In this case, the extracting technologies of the feature vector may include line spectral frequencies (LSF), filter bank energy, cepstrum, mel frequency cepstral coefficients (MFCC), linear predictive coefficient (LPC), and the like. Further, the controlling unit 160 calculates a value of probability between the extracted feature vector and at least one speaker model pre-stored in the storing unit (not shown) based on the extracted feature vector and performs a speaker identification determining whether or not the speaker is pre-stored in the storing unit based on the calculated value of probability or a speaker verification determining whether an accessing user is correct. That is, the controlling unit 160 performs a maximum likelihood estimation method for a plurality of speaker models pre-stored in the storing unit and as a result, selects the speaker model having the highest value of probability as a speaker phonating the voice. Further, in the performed result, when the highest value of probability is smaller than or equal to a predetermined threshold, the controlling unit 160 determines that no speaker phonating the voice exists among the preregistered speakers in the storing unit, such that it is determined that the speaker phonating the voice is not the preregistered speaker as the speaker identification result. Further, in the case of the speaker verification, the controlling unit 160 determines whether the speaker is the correct speaker or not by using a log-likelihood ratio (LLR) method. In addition, when it is determined that the speaker phonating the voice is not the preregistered speaker, the controlling unit 160 generates a new speaker model based on the extracted feature vector. In this case, the controlling unit 160 generates the speaker model by using a neural network, a Gaussian mixture model (GMM), a hidden Markov model (HMM), and the like. Further, the controlling unit 160 may generate the GMM as a speaker model by using an expectation maximization (EM) algorithm based on the extracted feature vector. In addition, the controlling unit 160 generates a universal background model (UBM) by using the EM algorithm based on the extracted feature vector and performs an adaptation algorithm pre-stored in the storing unit with respect to the generated UBM to generate a speaker model adapted to the phonating speaker, that is, the GMM. In this case, the adaptation algorithm pre-stored in the storing unit may include a maximum A posteriori (MAP), a maximum likelihood linear regression (MLLR), and Eigenvoice methods and the like.

The controlling unit 160 may perform a natural language processing with respect to the voice recognized data and control the TV provided with the apparatus 100 for removing noise for the sound/voice recognition so as to perform any function (or operation) based on the result of performing the natural language processing with respect to the voice recognized data.

When a motion of any object (for example, the user) included in the image information corresponds to a predetermined motion based on the image information (or the image signal) received through the camera included in the input unit 110, the controlling unit 160 may be configured so as to remove the TV audio signal which is included in the audio data including at least one of any sound signal received from the input unit 110 through the mike, the user's voice signal, and the TV audio signal outputted through the speaker 300 by using the constituent elements 110, 120, 130, 140, and 150. Herein, the predetermined motion of the user may include a gesture drawing a circle in a clockwise direction or a counterclockwise direction by using arms (or hands), a gesture drawing a line in vertical, horizontal, and diagonal directions (or, a sliding gesture in any direction), a gesture drawing a Mobius strip (or, a 8 letter shape), a gesture drawing a polygon, and the like.

The controlling unit 160 performs the voice recognition process based on the data (or the signal) from which the TV audio signal outputted from the adding and subtracting unit 150 is removed, allows the motion of any object included in the image information to correspond to any position (or coordinate) of a TV display unit (not shown) based on the image information received through the camera included in the input unit 110, and performs a function of any menu positioned on the corresponding coordinate based on the result of performing the voice recognition, outputs any screen positioned on the corresponding coordinate, or transmits any screen to any communication-connected terminal.

The controlling unit 160 detects the motion of any object (for example, the user) included in the image information based on the image information (or the image signal) received through the camera included in the input unit 110, performs a voice recognition process based on the data (or the signal) from which the TV audio signal outputted from the adding and subtracting unit 150 is removed, and controls TV function/operation (for example, including a channel, volume, mute, an environment (parameter), and the like) corresponding to the voice recognition result based on the voice recognition result and the motion of the detected object so as to perform predetermined function/operation (for example, up and down, function performance, stop, and the like) to correspond to the motion of the detected object.

When the motion of any object included in the image information corresponds to the predetermined motion based on the image information received through the camera included in the input unit 110, the controlling unit 160 may control the TV provided with the apparatus 100 for removing noise for the sound/voice recognition so as to perform a channel changing function, a volume control function, a mute function, a TV environment (parameter) setting function, and the like. Herein, the predetermined motion of the user may include a gesture drawing a circle in a clockwise direction or a counterclockwise direction by using arms (or hands), a gesture drawing a line in vertical, horizontal, and diagonal directions (or, a sliding gesture in any direction), a gesture drawing a Mobius strip (or, a 8 letter shape), a gesture drawing a polygon, and the like.

When a magnitude of the sound outputted through the speaker 300 is larger than a predetermined magnitude, the controlling unit 160 controls the TV functions corresponding to the voice recognition result including any content of the channel, the volume, the mute, and the environment from a time when the motion of the object is detected.

The controlling unit 160 performs an auto-correlation between the digitized audio data before being outputted through the speaker provided in the TV and the signal received through the mike in order to search a voice/sound recognition section.

The apparatus 100 for removing noise for the sound/voice recognition according to the exemplary embodiment of the present invention may use the image information received through the camera included in the above-described input unit 110 in order to detect the motion of the object and may further include a motion recognition sensor detecting the motion of the object. Herein, the motion recognition sensor may include a sensor such as a sensor recognizing the motion or position of the object, a geomagnetism sensor, an acceleration sensor, a gyro sensor, an inertial sensor, an altimeter, a vibration sensor, and the like and may further include sensors related to the motion recognition. Further, the motion recognition sensor detects information including an inclined direction of the object, an inclined angle and/or the inclined velocity of the object, a vibration direction and/or the vibration number in vertical, horizontal, diagonal directions, and the like. Herein, the detected information (the inclined direction, the inclined angle and/or the inclined velocity, and the vibration direction and/or the vibration number) is digitized through the digital signal processing process and the digitized information is transferred to the controlling unit 160.

As described above, it is possible to remove the TV sound corresponding to the noise signal by using the adaptive filter capable of adapting a filter coefficient in order to remove an analogous signal and perform the sound and/or voice recognition.

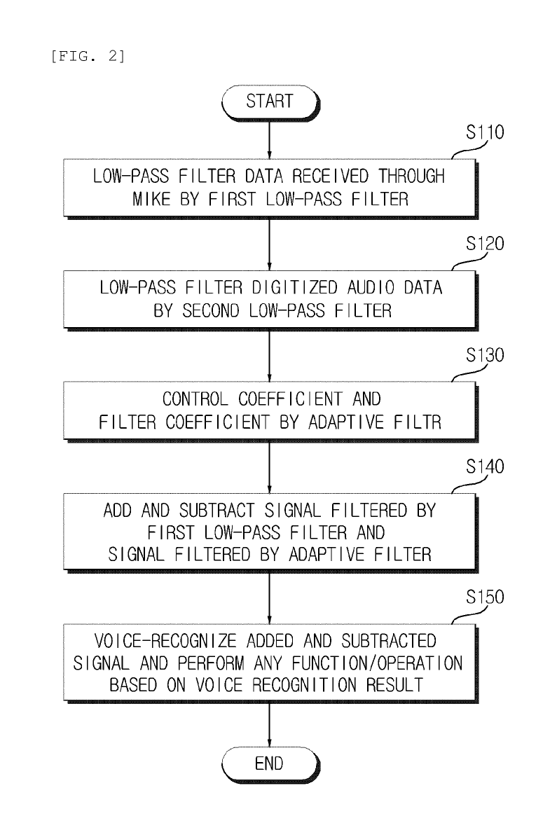

FIG. 2 is a flowchart illustrating a method for removing noise for sound/voice recognition according to an exemplary embodiment of the present invention.

Hereinafter, the flowchart will be described with reference to FIGS. 1 and 2.

First, the first low-pass filter 120 low-pass filters the data received through the mike included in the input unit 110 based on a predetermined first cutoff frequency (for example, 8 kHz). Here, the data received through the mike includes a sound signal, a voice signal, an audio signal outputted through a TV speaker, and the like (S110).

The second low-pass filter 130 filters the digitized audio signal before being outputted through the speaker 300 based on a predetermined second cutoff frequency (for example, 8 kHz). Here, the digitized audio signal before being outputted through the speaker 300 is a signal decoding the audio data (or the audio signal) included in any broadcasting signal by a decoder (not shown) provided in the TV or the controlling unit 160 (S120).

The adaptive filter 140 controls a coefficient of the adaptive filter 140 based on an output signal of the adding and subtracting unit 150 and filters an audio signal filtered by the second low-pass filter 130 based on the controlled coefficient. Here, the audio signal filtered by the second low-pass filter 130 includes the digitized audio signal before being outputted through the speaker 300 which corresponds to the noise signal and the output signal of the adding and subtracting unit 150 includes a signal adding and subtracting the audio signal filtered by the first low-pass filter 120 (including a sound signal, a voice signal, an output audio signal of the TV speaker 300, and the like) and the output signal of the adaptive filter 140 (S130).

The adding and subtracting unit 150 adds and subtracts the audio signal filtered by the first low-pass filter 120 (including a sound signal, a voice signal, an output audio signal of the TV speaker 300, and the like) and the output signal of the adaptive filter 140. In this case, when the coefficient value of the adaptive filter 140 is optimized, the adding and subtracting unit 150 may remove the output audio signal of the TV speaker 300 included in the audio signal filtered by the first low-pass filter 120 based on the output signal of the adaptive filter 140 corresponding to the output audio signal of the TV speaker 300 included in the audio signal filtered by the second low-pass filter 130 to output only the sound signal and/or voice signal components received through the mike to the controlling unit 160 (S140).

The controlling unit 160 performs the voice recognition process based on the output signal of the adding and subtracting unit 150 (for example, the sound signal and/or the voice signal where the output audio signal of the TV speaker 300 is removed among the signals received through the mike) and performs any function/operation control of the TV provided with the apparatus 100 for removing noise for the sound/voice recognition based on the result of performing the voice recognition.

For example, the controlling unit 160 performs the voice recognition process based on the output signal of the adding and subtracting unit 150 (including a voice signal called “screen print”) and controls the TV and a printer so as to output the screen displayed on the TV display unit to the printer (not shown) connected to the TV based on the content called “screen print” as the result of performing the voice recognition (S150).

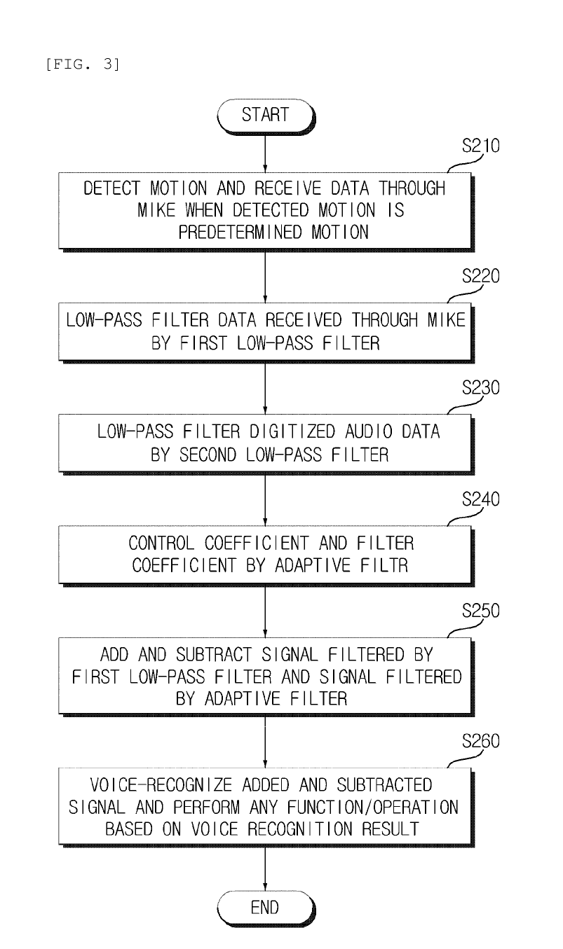

FIG. 3 is a flowchart illustrating a method of recognizing a walking state according to an exemplary embodiment of the present invention.

Hereinafter, the flowchart will be described with reference to FIGS. 1 and 3.

First, the controlling unit 160 detects the motion of any object included in the image information based on the image information received through the camera included in the input unit 110 and receives the data through the mike included in the input unit 110 when the motion of the detected object corresponds to the predetermined motion. Here, the data received through the mike includes a sound signal, a voice signal, an audio signal outputted through a TV speaker, and the like. Further, the predetermined motion includes a gesture drawing a circle in a clockwise direction or a counterclockwise direction, a sliding gesture in any direction (for example, a vertical direction, a horizontal direction, a diagonal direction, and the like), a gesture drawing a polygon, and the like (S210).

The first low-pass filter 120 low-pass filters the data received through the mike included in the input unit 110 based on a predetermined first cutoff frequency (for example, 8 kHz) (S220).

The second low-pass filter 130 filters the digitized audio signal before being outputted through the speaker 300 based on a predetermined second cutoff frequency (for example, 8 kHz). Here, the digitized audio signal before being outputted through the speaker 300 is a signal decoding the audio data (or the audio signal) included in any broadcasting signal by a decoder (not shown) provided in the TV or the controlling unit 160 (S230).

The adaptive filter 140 controls a coefficient of the adaptive filter 140 based on an output signal of the adding and subtracting unit 150 and filters the audio signal filtered by the second low-pass filter 130 based on the controlled coefficient. Here, the audio signal filtered by the second low-pass filter 130 includes the digitized audio signal before being outputted through the speaker 300 which corresponds to the noise signal and the output signal of the adding and subtracting unit 150 includes a signal adding and subtracting the audio signal filtered by the first low-pass filter 120 (including a sound signal, a voice signal, an output audio signal of the TV speaker 300, and the like) and the output signal of the adaptive filter 140 (S240).

The adding and subtracting unit 150 adds and subtracts the audio signal filtered by the first low-pass filter 120 (including a sound signal, a voice signal, an output audio signal of the TV speaker 300, and the like) and the output signal of the adaptive filter 140. In this case, when the coefficient value of the adaptive filter 140 is optimized, the adding and subtracting unit 150 may remove the output audio signal of the TV speaker 300 included in the audio signal filtered by the first low-pass filter 120 based on the output signal of the adaptive filter 140 corresponding to the output audio signal of the TV speaker 300 included in the audio signal filtered by the second low-pass filter 130 to output only the sound signal and/or voice signal components received through the mike to the controlling unit 160 (S250).

The controlling unit 160 performs the voice recognition process based on the output signal of the adding and subtracting unit 150 (for example, the sound signal and/or the voice signal where the output audio signal of the TV speaker 300 is removed among the signals received through the mike) and performs any function/operation control of the TV provided with the apparatus 100 for removing noise for the sound/voice recognition based on the result of performing the voice recognition.

For example, the controlling unit 160 performs the voice recognition process based on the output signal of the adding and subtracting unit 150 (including a voice signal called “screen print”) and transmits the screen displayed on the TV display unit to any terminal (not shown) connected to a communicating unit (not shown) included in the TV based on the content called “screen print” as the result of performing the voice recognition (S260).

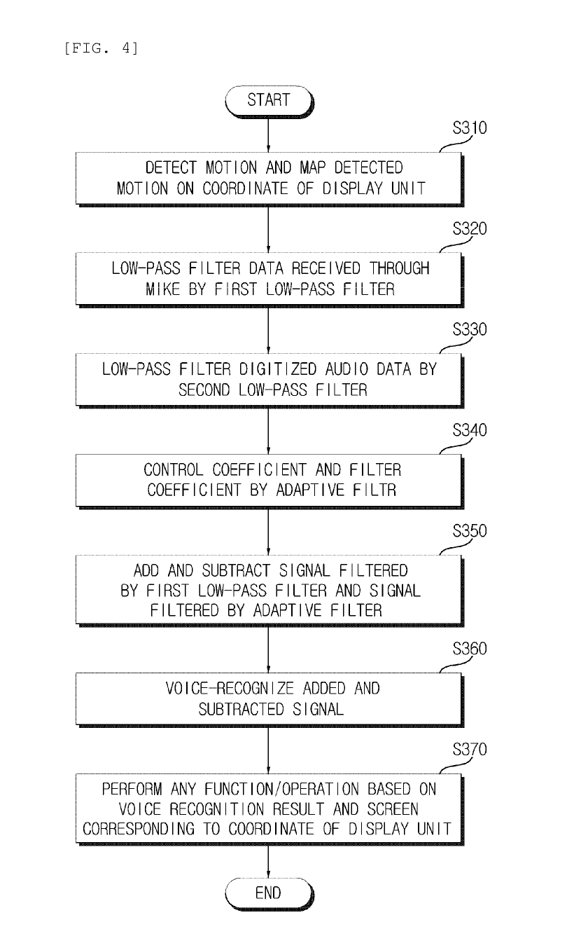

FIG. 4 is a flowchart illustrating a method of recognizing a walking state according to an exemplary embodiment of the present invention.

Hereinafter, the flowchart will be described with reference to FIGS. 1 and 4.

First, the controlling unit 160 detects a motion (or a position) of any object included in the image information based on the image information received through the camera included in the input unit 110 and allows the detected motion of any object to correspond to (be mapped on) any position (or any coordinate) of a TV display unit (not shown) provided with the apparatus 100 for removing noise for the sound/voice recognition.

For example, the controlling unit 160 detects position information of a user's hand in the image information received through the camera and allows the detected position information of the user's hand to correspond to a position (or a coordinate) of the TV display unit (S310).

The first low-pass filter 120 low-pass filters the data received through the mike included in the input unit 110 based on the predetermined first cutoff frequency (for example, 8 kHz) (S320).

The second low-pass filter 130 filters the digitized audio signal before being outputted through the speaker 300 based on a predetermined second cutoff frequency (for example, 8 kHz). Here, the digitized audio signal before being outputted through the speaker 300 is a signal decoding the audio data (or the audio signal) included in any broadcasting signal by a decoder (not shown) provided in the TV or the controlling unit 160 (S330).

The adaptive filter 140 controls a coefficient of the adaptive filter 140 based on an output signal of the adding and subtracting unit 150 and filters the audio signal filtered by the second low-pass filter 130 based on the controlled coefficient. Here, the audio signal filtered by the second low-pass filter 130 includes the digitized audio signal before being outputted through the speaker 300 which corresponds to the noise signal and the output signal of the adding and subtracting unit 150 includes a signal adding and subtracting the audio signal filtered by the first low-pass filter 120 (including a sound signal, a voice signal, an output audio signal of the TV speaker 300, and the like) and the output signal of the adaptive filter 140 (S340).

The adding and subtracting unit 150 adds and subtracts the audio signal filtered by the first low-pass filter 120 (including a sound signal, a voice signal, an output audio signal of the TV speaker 300, and the like) and the output signal of the adaptive filter 140. In this case, when the coefficient value of the adaptive filter 140 is optimized, the adding and subtracting unit 150 may remove the output audio signal of the TV speaker 300 included in the audio signal filtered by the first low-pass filter 120 based on the output signal of the adaptive filter 140 corresponding to the output audio signal of the TV speaker 300 included in the audio signal filtered by the second low-pass filter 130 to output only the sound signal and/or voice signal components received through the mike to the controlling unit 160 (S350).

The controlling unit 160 performs the voice recognition process based on the output signal of the adding and subtracting unit 150 (for example, the sound signal and/or the voice signal where the output audio signal of the TV speaker 300 is removed among the signals received through the mike) (S360).

The controlling unit 160 controls the TV so as to perform any function/operation based on the result of performing the voice recognition and the screen corresponding to any position (coordinate) of the TV display unit.

For example, the controlling unit 160 controls the TV and a printer based on the output signal of the adding and subtracting unit 150 (including a voice signal called “screen print”) and the screen corresponding to any position (coordinate) of the TV display unit (for example, a first screen among a plurality of segmented screens) so as to output the screen displayed on the TV display unit (for example, the first screen) to the printer (not shown) connected to the TV (S370).

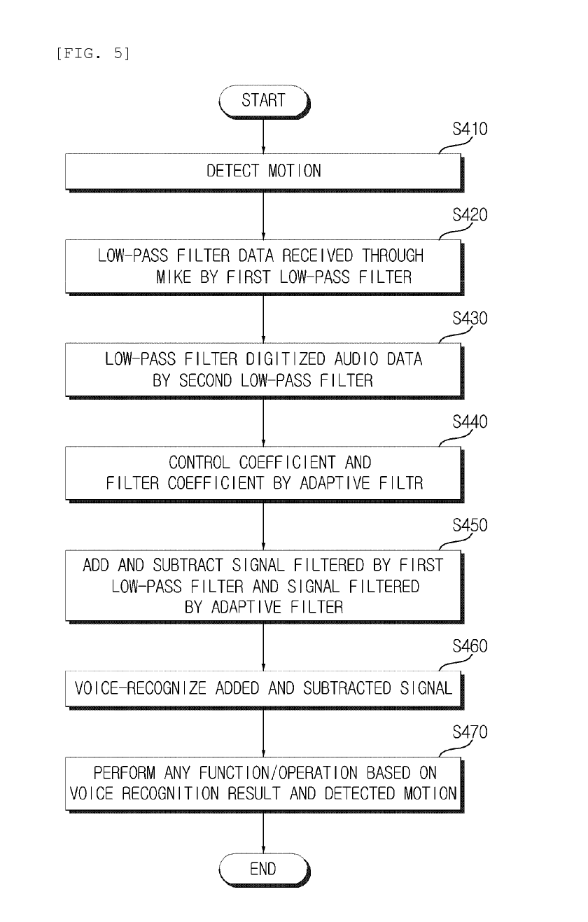

FIG. 5 is a flowchart illustrating a method of recognizing a walking state according to an exemplary embodiment of the present invention.

Hereinafter, the flowchart will be described with reference to FIGS. 1 and 5.

First, the controlling unit 160 detects a motion of any object included in the image information based on the image information received through the camera included in the input unit 110 (S410).

The first low-pass filter 120 low-pass filters the data received through the mike included in the input unit 110 based on a predetermined first cutoff frequency (for example, 8 kHz) (S420).

The second low-pass filter 130 filters the digitized audio signal before being outputted through the speaker 300 based on a predetermined second cutoff frequency (for example, 8 kHz). Here, the digitized audio signal before being outputted through the speaker 300 is a signal decoding the audio data (or the audio signal) included in any broadcasting signal by a decoder (not shown) provided in the TV or the controlling unit 160 (S430).

The adaptive filter 140 controls a coefficient of the adaptive filter 140 based on an output signal of the adding and subtracting unit 150 and filters the audio signal filtered by the second low-pass filter 130 based on the controlled coefficient. Here, the audio signal filtered by the second low-pass filter 130 includes the digitized audio signal before being outputted through the speaker 300 which corresponds to the noise signal and the output signal of the adding and subtracting unit 150 includes a signal adding and subtracting the audio signal filtered by the first low-pass filter 120 (including a sound signal, a voice signal, an output audio signal of the TV speaker 300, and the like) and the output signal of the adaptive filter 140 (S440).

The adding and subtracting unit 150 adds and subtracts the audio signal filtered by the first low-pass filter 120 (including a sound signal, a voice signal, an output audio signal of the TV speaker 300, and the like) and the output signal of the adaptive filter 140. In this case, when the coefficient value of the adaptive filter 140 is optimized, the adding and subtracting unit 150 may remove the output audio signal of the TV speaker 300 included in the audio signal filtered by the first low-pass filter 120 based on the output signal of the adaptive filter 140 corresponding to the output audio signal of the TV speaker 300 included in the audio signal filtered by the second low-pass filter 130 to output only the sound signal and/or voice signal components received through the mike to the controlling unit 160 (S450).

The controlling unit 160 performs the voice recognition process based on the output signal of the adding and subtracting unit 150 (for example, the sound signal and/or the voice signal where the output audio signal of the TV speaker 300 is removed among the signals received through the mike) (S460).

The controlling unit 160 controls the TV so as to perform any function/operation based on the result of performing the voice recognition and the detected motion of the object. Here, messages (for example, including a channel, volume, mute, an environment (parameter), and the like) corresponding to any function/operation of the TV are included in the result of performing the voice recognition.

As an example, in the case where the ‘channel’ is included in the result of performing the voice recognition and the detected motion of the object is the gesture drawing the circle in a predetermined counterclockwise direction, the controlling unit 160 reduces the TV channel by one step.

As another example, in the case where the ‘mute’ is included in the result of performing the voice recognition and the detected motion of the object is the gesture sliding in a predetermined diagonal direction, the controlling unit 160 performs the TV mute function (S470).

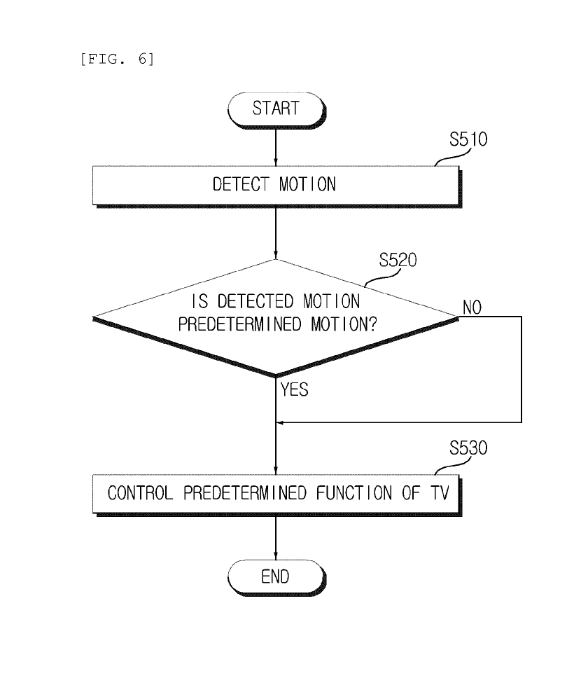

FIG. 6 is a flowchart illustrating a method of recognizing a walking state according to an exemplary embodiment of the present invention.

Hereinafter, the flowchart will be described with reference to FIGS. 1 and 6.

First, the controlling unit 160 detects a motion of any object included in the image information based on the image information received through the camera included in the input unit 110 (S510).

The controlling unit 160 determines whether a detected motion of the object corresponds to a predetermined motion. Further, the predetermined motion includes a gesture drawing a circle in a clockwise direction or a counterclockwise direction, a sliding gesture in any direction (for example, a vertical direction, a horizontal direction, a diagonal direction, and the like), a gesture drawing a polygon, and the like (S520).

In the determined result, in the case where the detected motion of the object corresponds to the predetermined motion, the controlling unit 160 controls a predetermined function of the TV provided with the apparatus 100 for removing noise for the sound/voice recognition. That is, in the case where the detected motion of the object corresponds to the predetermined motion, the controlling unit 160 performs any one function among a channel change function, a volume control function, a mute function, and an environment (or parameter) setting function of the TV.

As an example, in the case where the detected motion of the object is the gesture drawing the circle in a predetermined clockwise direction, the controlling unit 160 increases the TV volume by one step.

As another example, in the case where the detected motion of the object is the gesture sliding in a predetermined vertical direction, the controlling unit 160 decreases the TV channel by one step (S530).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An apparatus for removing noise for sound/voice recognition which removes a noise signal included in a signal received through a mike, the apparatus comprising:
a first low-pass filter filtering the signal received through the mike based on a predetermined first cutoff frequency;
a second low-pass filter filtering digitized audio data before being outputted through a speaker provided in a TV based on a predetermined second cutoff frequency;
an adaptive filter controlling a coefficient of the filter based on an output signal of an adding and subtracting unit and filtering an output signal of the second low-pass filter based on the controlled coefficient;
an adding and subtracting unit adding or subtracting an output signal of the first low-pass filter and an output signal of the adaptive filter; and
a controlling unit voice-recognizing a signal outputted from the adding and subtracting unit and controlling a function or an operation of the TV based on the voice recognition result.

2. The apparatus of claim 1, wherein the mike receives the signal through the mike when a predetermined motion of an object is detected in the image information received through the camera.

3. The apparatus of claim 1, wherein the first cutoff frequency or the second cutoff frequency is 8 kHz.

4. The apparatus of claim 2, wherein the signal received through the mike includes a sound signal, a voice signal, and an audio signal outputted through the speaker.

5. The apparatus of claim 1, wherein the controlling unit outputs a screen displayed on a display unit of the TV based on the voice recognition result or transmits the screen to any communication-connected terminal.

6. The apparatus of claim 2, wherein the predetermined motion of the object includes any one of a gesture drawing a circle in a clockwise direction or a counterclockwise direction, a sliding gesture in any direction, and a gesture drawing a polygon.

7. The apparatus of claim 2, wherein the controlling unit controls a function of the TV including a content of any one of a channel, volume, mute, and an environment which corresponds to the voice recognition result from a time when the motion of the object is detected.

8. The apparatus of claim 2, wherein the controlling unit performs an auto-correlation between the digitized audio data before being outputted through the speaker provided in the TV and the signal received through the mike.

9. A method for removing noise for sound/voice recognition which removes a noise signal included in a signal received through a mike, the method comprising:
detecting a motion of an object included in image information received through a camera;
receiving a signal through the mike when the detected motion of the object is a predetermined motion;
filtering the signal received through the mike through a first low-pass filter based on a predetermined first cutoff frequency;
filtering digitized audio data before being outputted through a speaker provided in a TV through a second low-pass filter based on a predetermined second cutoff frequency;
controlling a coefficient of an adaptive filter based on an output signal of an adding and subtracting unit and filtering an output signal of the second low-pass filter through the adaptive filter based on the controlled coefficient;
adding or subtracting an output signal of the first low-pass filter and an output signal of the adaptive filter;
voice-recognizing an output signal according to the addition or subtraction; and
controlling a function or an operation of the TV based on the voice recognition result.

10. The method of claim 9, wherein the signal received through the mike includes a sound signal, a voice signal, and an audio signal outputted through the speaker.

11. The method of claim 9, wherein the controlling of the function or operation of the TV based on the voice recognition result outputs a screen displayed on a display unit of the TV through a printer based on the voice recognition result or transmits the screen to any communication-connected terminal.

12. The method of claim 9, wherein the predetermined motion of the object includes any one of a gesture drawing a circle in a clockwise direction or a counterclockwise direction, a sliding gesture in any direction, and a gesture drawing a polygon.

13. The method of claim 9, further comprising: controlling a function of the TV including a content of any one of a channel, volume, mute, and an environment which corresponds to the voice recognition result from a time when the motion of the object is detected.

14. The method of claim 9, further comprising: performing an auto-correlation between the digitized audio data before being outputted through the speaker provided in the TV and the signal received through the mike.
